(19) United States
(12) Patent Application Publication
(10) Pub. No.: US 2017/0060507 A1
(43) Pub. Date: Mar. 2, 2017

(54) SERVICE FOR CREATING A PERSONALIZED UNIVERSAL PRINT DRIVER

(71) Applicant: XEROX CORPORATION, Norwalk, CT (US)

(72) Inventor: David L. SALGADO, Victor, NY (US)

(21) Appl. No.: 14/836,040

(22) Filed: Aug. 26, 2015

(51) Int. Cl. G06F 3/12

(52) U.S. Cl. CPC G06F 3/1297; G06F 3/1205; G06F 3/1254; G06F 3/1257; G06F 3/1258; G06F 3/1276

(57) ABSTRACT

A method of generating a personalized universal printer driver for use with a printing device is provided. The method includes presenting a checklist of printing devices supported by a personalization service; allowing a development user to select or deselect each of the printing devices on the checklist; generating a printing feature list, the printing feature list containing printing features of the selected printing devices, the printing feature list having options for each of the printing features on the printing feature list; presenting the printing feature list to the development user; allowing the development user to create personalizations by selecting among the printing features on the printing features list and among the options for each of the selected printing features on the printing feature list; and generating a driver installation package that includes the personalized universal printer driver including the personalizations.

### BACKGROUND

Disclosed herein is a system and method for creating a personalized universal print driver.

Embodiments of the disclosure include generating a personalized universal print driver that provides equivalent features offered in a particular printing device's traditional printer driver.

### SUMMARY

A universal printer driver (UPD) is a single printer driver that can print to many different printing devices. There are two predominant types of universal printer drivers: a basic UPD and an advanced UPD. A basic UPD provides a common limited feature set regardless of the printing device it is connected to. An advanced UPD tries to provide enhanced functionality tailored to the printing device it is connected to. Regardless of the type of UPD, a goal is to provide the ability to personalize the UPD to meet a particular user's printing needs.

Embodiments of the disclosure propose a software service for the generation of a personalized universal printer driver. The personalization service enables the user to generate a UPD containing only the features and feature options desired by the user. It allows users to efficiently create a customized print driver that is tailored to meet their needs. It includes capabilities not found (e.g. adding/deleting pre-defined watermarks) with existing driver pre-configuration solutions. The method where the underlying product data files are modified to reflect the personalizations results in better print-time performance and a smaller driver footprint (the size of the installed driver files). The personalization service is easily extendable to add new personalization steps when new features/workflows are added to the printer driver platform.

An embodiment of the disclosure may include a method of generating a personalized universal printer driver for use with a printing device, the method including presenting a checklist of printing devices supported by a personalization service; allowing a development user to select or deselect each of the printing devices on the checklist; generating a printing feature list, the printing feature list containing printing features of the selected printing devices, the printing feature list having options for each of the printing features on the printing feature list; presenting the printing feature list to the development user; allowing the development user to create personalizations by selecting among the printing features on the printing feature list and among the options for each of the selected printing features on the printing feature list; and generating a driver installation package that includes the personalized universal printer driver including the personalizations.

Another embodiment of the disclosure may include a non-transitory computer readable medium having executable instructions recorded thereon that, when executed by a processor, cause the processor to execute steps of a method for generating a personalized universal printer driver for use with a printing device, including presenting a checklist of printing devices supported by a personalization service; allowing a development user to select or deselect each of the printing devices on the checklist; generating a printing feature list, the printing feature list containing printing features of the selected printing devices, the printing feature list having options for each of the printing features on the printing feature list; presenting the printing feature list to the development user; allowing the development user to create personalizations by selecting any of the printing features on the printing feature list and among the options for each of the selected printing features on the printing feature list; and generating the personalized universal printer driver such that the personalized universal printer driver includes the selections made by the development user.

### BRIEF DESCRIPTION OF THE DRAWINGS

FIG. 1 shows an example of a system in accordance with embodiments of the disclosure;

FIG. 2 shows an example of a method in accordance with embodiments of the disclosure;

FIG. 3 shows an example of a user interface in accordance with embodiments of the disclosure; and

FIG. 4 shows an example of a user interface in accordance with embodiments of the disclosure.

### DETAILED DESCRIPTION

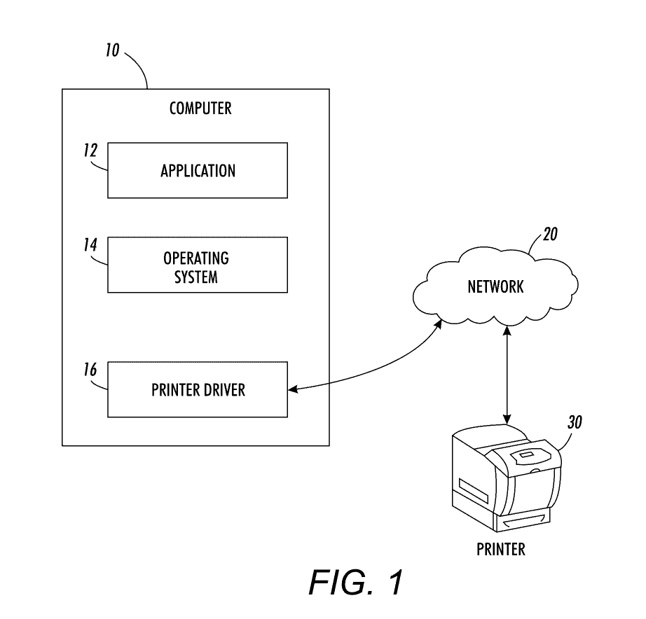

FIG. 1 is a block diagram that shows an example of a printing system. In various embodiments, additional blocks may be included, some blocks may be removed, and/or blocks may be connected or arranged differently from what is shown.

In the embodiment of FIG. 1, the printing system can include a computer 10. Software installed on computer 10 can include one or more applications 12, an operating system 14, and a printer driver 16. Applications 12 can include computer applications, applets, firmware, and other computer programs for manipulating text, graphics, and display data. Applications 12 are managed by operating system 14, and can create and edit documents and generate print jobs to print the documents. Operating system 14 can be any commercial, open-source, or proprietary operating system or platform.

Printer driver 16 can be a device driver that converts a print job generated by applications 12 into print commands in a format that can be interpreted by a printer 30, such as a printer control language, a page description language, a page description markup language, a bitmap, and the like.

In various embodiments, computer 10 can be implemented as any type of computer system, such as a server computer, a desktop computer, a virtual machine, a laptop, a mobile device, a tablet computer, a smartphone, a personal digital assistant, and the like. Computer 10 can include components of a conventional computer system, for example. In various embodiments, computer 10 in the printing system can be configured to communicate with printer 30 and/or other printers or computer systems. As illustrated in FIG. 1, for example, printer driver 16 can be implemented to run on computer 10, which is communicatively coupled to printer 30 via a network 20. Network 20 can include one or more communication networks, such as a local area network, a wide area network, a cellular network, the Internet, a cloud-based network, and the like, or any combination thereof. Printer driver 16 can also communicate and/or interact with a user via network 20. For instance, printer driver 16 can provide one or more user interfaces to communicate with the user via network 20, which can include a print dialogue, a web page, a web portal, an electronic mail application, a messaging application, a media player, and other types of network-based interfaces known to one skilled in the art. As such, the user can utilize printer driver 16 running on computer 10 to send print jobs via network 20 to printer 30.

A universal printer driver (UPD) is a single printer driver that can print to many different printing devices. There are two predominant types of universal printer drivers: a basic UPD and an advanced UPD. A basic UPD provides a common limited feature set regardless of the printing device it is connected to. An advanced UPD tries to provide enhanced functionality tailored to the printing device it is connected to. Regardless of the type of UPD, a goal is to provide the ability to personalize the UPD to meet a particular user's printing needs.

Architecturally, the core of the UPD personalization service is the printer driver platform. For an advanced UPD, the driver platform employs a set of product data files (one set for each printing device that it supports) to describe a particular printing device. One example breakdown of these description product data files are: 1) specifies the installable options, features and feature options (with default values) for the printing device (called the capabilities file); 2) specifies the model branding and system object ID for each model; 3) specifies the printing constraints; and 4) specifies the device mimics A set of product data files may exist for items that would apply to all products supported by the UPD (e.g. pre-created watermarks file, driver branding file, etc.). The term “product” is understood to include, for example, printers, multi-function devices, and other devices that use the printer driver.

Examples of features and their associated feature options are (1) the feature of page size with options of letter, legal, A4, etc.; (2) the feature of 2-Sided Printing with options of 1-Sided Print, 2-Sided Print, 2-Sided Print Flip on Short Edge, etc.; (3) the feature of print quality with the options of standard, enhanced, photo, etc.; and (4) the feature of stapling with the options of 1-staple, 2-staple, 4-staple, etc. These examples are only a few of the possible features and only of a few of the possible feature options.

For a basic UPD, a single set of these product data files are employed since limited common features and constraints are used regardless of the printing device connected. To create the personalized settings, a user accesses a cloud-based (for example) UPD personalization service. The personalization service could be, for example, hosted in a public cloud or within a company's private network.

In this disclosure, the term “end user” is understood to be a person that uses a resultant personalized printer driver. In this disclosure, the term “development user” is understood to be a person that develops the personalized universal printer driver. In some cases the development user is also an end user.

The personalization process includes a number of a steps. The personalization service presents a check list of all the printing devices it supports (i.e. the ones it has product data files for) to the development user with, for example, all devices pre-selected. The development user has the option to clear the list and manually specify a limited set of printing devices to be used. Alternatively, the development user can request the personalization service to discover the printing devices within the user's local network. The personalization service can employ standard device discovery algorithms to find the printing devices and presents the discovered printing devices at the top of the device check list. The development user still has the ability to add/remove devices from the list.

Once the printing device list is finalized, the development user requests the personalization service to generate the feature and feature option list. To do this, the personalization service reads each device's capability files and makes a superset of features and feature options. The personalization service presents the list of features and feature options (with default) to the development user for modification.

In embodiments of the disclosure, the personalization service provides (for example) the following general feature personalization options: remove feature to be presented, remove feature options to be presented; restrict a feature to a single feature option; modify a feature's default value; specify a feature that should not be displayed; and change the display string for a feature or feature option.

In addition, the personalization service offers the development user the ability to specify whether the printer driver should display a “My Features” tab. For the “My Features” tab, the development user can select from the feature list 10 (for example) features to be displayed in it. The development user gets to choose the location of each feature in the “My Features” tab. When a “My Features” tab is specified, the printer driver can display this tab as the first printer driver tab shown, while still displaying all other tabs. Features on the “My Features” tab can also be displayed in their original tab(s).

The personalization service allows the development user to additionally personalize the watermark/annotation feature by, for example: selecting which pre-created text watermarks (e.g. Confidential, Draft, Personal) should be displayed; creating their own watermarks to be included as a pre-created watermark; and specifying whether the end user has the ability to delete the pre-created watermarks.

A “printer driver saved setting” is a named collection of the features set to pre-defined feature values for the purpose of quick access to commonly used feature settings. An “application saved setting” is the default set of feature values to be used when printing from a specific application. The personalization service allows the end development to personalize the saved settings by, for example: (1) adding pre-created print driver saved settings; (2) adding pre-created application saved settings; and (3) specifying whether the end user has the ability to delete or modify the pre-created print driver saved settings or application saved settings.

The personalization service provides the ability to add a company logo to be displayed in the printer driver. The printer driver will automatically scale the logo to fit within the pre-defined space.

When the development user has finished specifying their personalizations, they execute the personalization service's driver generation function. The development user specifies what page description language or PDL (ex. PostScript, PCL6) to create and whether the driver should be 32 or 64 bit. Driver generation will create a driver installation package with the personalizations applied.

This disclosure proposes two methodologies for the personalizations to be actually applied to the printer driver.

In the first method, a set of personalization files that contain the personalizations are created and included in the driver's installation package. When the installed driver is instantiated as part of a print request, it accesses the personalization files and applies all relevant personalizations prior to displaying its user interface. In this method, the core product data files used by the universal print driver include all their original data and the personalizations are in addition to that data. The driver installation package could, for example, include a set of instructions to access the core product data files.

In the second method, the existing product data files (for all products selected by the development user) are modified to reflect the personalizations. The personalization service generates a driver installation package that includes these modified product data files. When the installed driver is instantiated as part of a print request, it simply accesses the installed product data files (which reflect the modifications) for determining what to display on its user interface. In this method, the core product data files are actually modified and features and feature options that are not included in the personalizations are deleted from the core product data files. This method has the advantage that the driver footprint is smaller. A possible disadvantage to this method is that if a deleted feature or feature option is desired in the future, it no longer exists.

This disclosure proposes the ability for a development user to capture their selected personalizations in a personalization profile. With the personalization service, a development user should be able to add, delete, modify, and apply any personalization profile they have access to. This disclosure also proposes that the personalization service can be used to create personalized traditional (device-specific) printer drivers.

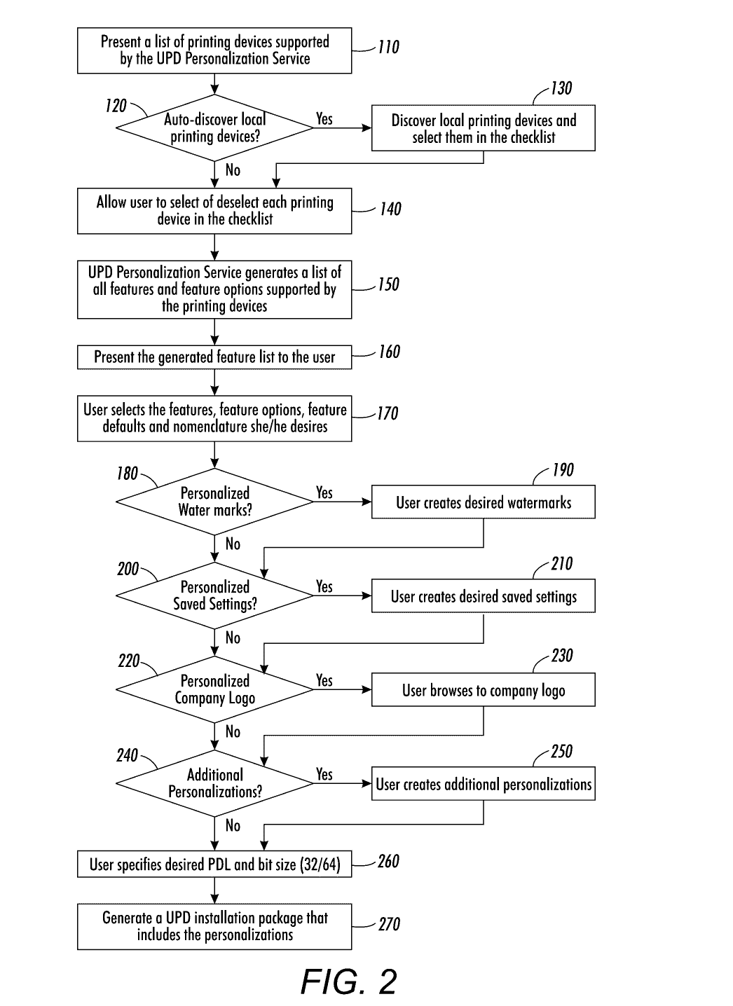

FIG. 2 shows an example of a method in accordance with embodiments of the disclosure. FIG. 2 shows an example of a method of generating a personalized universal print driver for use with a printing device. At 110 a checklist of printing devices supported by the UPD personalization service is presented to a development user. At 120 a decision to auto-discover local printing devices is made. If it is decided to auto-discover in 120, the discovered printing devices are selected in a printing device checklist in 130. At 140 a development user is allowed to select or deselect each of the printing devices on the checklist (those discovered as well as possibly other printing devices). At 150 a printing feature list is generated, the printing feature list containing printing features of the selected printing devices, the printing feature list has options for each of the printing features on the printing feature list. At 160 the printing feature list is presented to the development user. At 170-250 the development user is allowed to create personalizations by selecting among the options for each of the printing features on the printing feature list, as well as create personalized watermarks, saved settings, company logos, and additional personalizations. At 260 the development user specifies other specifications of the driver installation package such as, for example, the desired PDL and bit size. At 270 a driver installation package is generated that includes the personalized universal print driver including the personalizations.

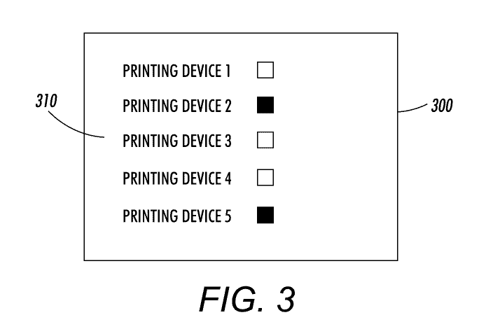

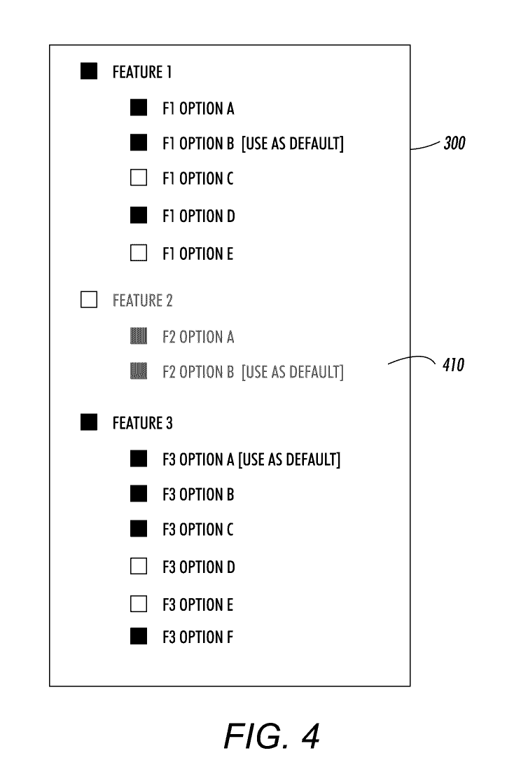

FIGS. 3 and 4 show examples of a user interface in accordance with embodiments of the disclosure. In FIG. 3, the development user is shown on a display 300 a list 310 of printing devices supported. The development user than selects the printing devices that are to be supported by the personalized universal print driver. In this example, the development user has chosen printing devices 2 and 5.

In FIG. 4, the development user is shown on display 300 a list 410 of feature options for printing feature 1, 2 and 3. The development user than selects the feature options that are to be included in the personalized universal print driver. In this example, the development user has chosen Options A, B and D for Feature 1; and Options A, B, C and F for Feature 3. No options are selected for Feature 2 because Feature 2 is not available for this printing device (as indicated by a ghosted font). A similar screen would be shown to the development user for every printing feature supported.

After the development user has completed the selection of printing devices, features, and feature options, the personalized universal print driver is developed as explained above. The personalized UPD is then made available to end users who, depending on the amount of authority given to the end user, can use the personalized UPD as is or can further modify it.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method performed by a computer for generating a personalized universal printer driver for use with a printing device, the method comprising:
automatic discovery of printing devices existing on a network used by an end user;
presenting at a user interface a checklist of printing devices supported by a personalization service;
automatic inclusion in the checklist of the printing devices existing on the network used by the end user;
allowing a development user to select or deselect through the user interface each of the printing devices on the checklist;
generating a printing feature list, the printing feature list containing printing features of the selected printing devices, the printing feature list having options for each of the printing features on the printing feature list;
wherein the generating a printing feature list includes reading a capabilities file of each of the selected printing devices;
presenting the printing feature list to the development user at the user interface;
allowing the development user to create personalizations by selecting among the printing features on the printing feature list and among the options for each of the selected printing features on the printing feature list; and
generating a driver installation package that includes the personalized universal print driver including the personalizations;
creating a saved setting, the saved setting being a named collection of particular ones of the features set to pre-defined feature values;
wherein the driver installation package includes a set of personalization files that contain the personalizations, and the personalization files are configured to be accessed and relevant ones of the personalizations applied when a print request is made;
wherein the driver installation package includes existing product data files and the personalization files, and the existing product data files are not modified by the personalizations;
wherein the development user can specify whether the end user has permission to delete or modify a pre-created print driver saved settings or application saved settings;
wherein the development user is allowed to modify nomenclature of one of the features or one of the feature options.

2. The method of claim 1, wherein the development user can further specify a desired page description language (PDL) and bit size.

3. The method of claim 1, wherein development user is allowed to remove options for a particular printing feature from the printing feature list,
the development user is allowed to restrict a printing feature to a single option on the printing feature list,
the development user is allowed to modify a default value of a particular printing feature on the printing feature list, and
the development user is allowed to remove a particular printing feature from the printing feature list.

4. The method of claim 1, wherein the development user is allowed to remove options for a particular printing feature from the printing feature list.

5. The method of claim 1, wherein the development user is allowed to restrict a printing feature to a single option on the printing feature list.

6. The method of claim 1, wherein the development user is allowed to modify a default value of a particular printing feature on the printing feature list.

7. The method of claim 1, wherein the development user is allowed to remove a particular printing feature from the printing feature list.

8. The method of claim 1, further comprising allowing the development user to select which pre-created watermarks from a group of pre-created watermarks are to be included in the personalized universal print driver for use by an end user.

9. The method of claim 8, further comprising allowing the development user to create a watermark to be included as one of the watermarks included in the personalized universal print driver.

10. The method of claim 8, further comprising allowing the development user to specify whether the end user is able to delete any of the watermarks to be included in the personalized universal printer driver.

11-13. (canceled)

14. The method of claim 1, wherein the driver installation package includes existing product data files that are modified to reflect the personalizations.

15. The method of claim 14, wherein printing features and feature options not included in the personalizations are deleted from the existing product data files.

16. The method of claim 15, wherein the development user is allowed to remove options for a particular printing feature from the printing feature list,
the development user is allowed to restrict a printing feature to a single option on the printing feature list,
the development user is allowed to modify a default value of a particular printing feature on the printing feature list, and
the development user is allowed to remove a particular printing feature from the printing feature list.

17. The method of claim 16, further comprising allowing the development user to select which pre-created watermarks from a group of pre-created watermarks are to be included in the personalized universal print driver for use by an end user.

18. The method of claim 5, wherein the development user is allowed to remove options for a particular printing feature from the printing feature list,
the development user is allowed to restrict a printing feature to a single option on the printing feature list,
the development user is allowed to modify a default value of a particular printing feature on the printing feature list, and
the development user is allowed to remove a particular printing feature from the printing feature list.

19. The method of claim 18, further comprising allowing the development user to select which pre-created watermarks from a group of pre-created watermarks are to be included in the personalized universal printer driver for use by an end user.

20. A non-transitory computer readable medium having executable instructions recorded thereon that, when executed by a processor, cause the processor to execute steps of a method for generating a personalized universal printer driver for use with a printing device, comprising:
automatic discovery of printing devices existing on a network used by an end user;
presenting a checklist of printing devices supported by a personalization service;
automatic inclusion in the checklist of the printing devices existing on the network used by the end user;
allowing a development user to select or deselect each of the printing devices on the checklist;
generating a printing feature list, the printing feature list containing printing features of the selected printing devices, the printing feature list having options for each of the printing features on the printing feature list;
presenting the printing feature list to the development user;
allowing the development user to create personalizations by selecting among the printing features on the printing feature list and among the options for each of the selected printing features on the printing feature list;
creating a saved setting, the saved setting being a named collection of particular ones of the features set to pre-defined feature values;
wherein the driver installation package includes a set of personalization files that contain the personalizations, and the personalization files are configured to be accessed and relevant ones of the personalizations applied when a print request is made;
wherein the development user can specify whether the end user has permission to delete or modify a pre-created print driver saved settings or application saved settings;
wherein the development user is allowed to modify nomenclature of one of the features or one of the feature options;
wherein the development user is allowed to remove options for a particular printing feature from the printing feature list,
the development user is allowed to restrict a printing feature to a single option on the printing feature list,
the development user is allowed to modify a default value of a particular printing feature on the printing feature list,
the development user is allowed to remove a particular printing feature from the printing feature list, and
the development user is allowed to select which pre-created watermarks from a group of pre-created watermarks are to be included in the personalized universal printer driver for use by the end user;
wherein the driver installation package includes existing product data files and the personalization files, and the existing product data files are not modified by the personalizations; and
generating the personalized universal print driver such that the personalized universal printer driver includes the selections made by the development user.

21. (canceled)
